(19) United States
(12) Patent Application Publication
(10) Pub. No.: US 2013/0250217 A1
(43) Pub. Date: Sep. 26, 2013

(54) Liquid Crystal Display Panel and Manufacturing Method Thereof

(71) Applicant: Xiaolong Ma, Shenzhen (CN)

(72) Inventor: Xiaolong Ma, Shenzhen (CN)

(73) Assignee: Shenzhen China Star Optelectronics technology Co., LTD., Shenzhen (JP)

(21) Appl. No.: 13/521,698

(22) PCT Filed: Apr. 26, 2012
(86) PCT No.: PCT/CN12/74757

§ 371 Date: Jul. 11, 2012

(30) Foreign Application Priority Data
Mar. 23, 2012 (CN) 201210081667.X

(51) Int. Cl. G02F 1/1335; B32B 37/26

(52) U.S. Cl. 349/106; 156/275.5

(57) ABSTRACT

The present invention provides a liquid crystal display panel and manufacturing method thereof. The manufacturing method includes: disposing a first and a second substrate oppositely, first substrate comprising a color filter (CF) array area and a first non-display area disposed in peripheral of CF array area, first substrate or second substrate coated with radiation curing agent corresponding to first non-display area; using curing radiation to shine on first substrate from a side of first substrate away from second substrate so that incident curing radiation to CF array area absorbed by CF array area, and incident curing radiation to first non-display area curing radiation curing agent to adhere first and second substrates. The present invention effectively solves insufficient curing problem caused by shielding of metal routes in peripheral of thin film transistor array area and reduces manufacture cost of liquid crystal display panel without UV mask.

### BACKGROUND OF THE INVENTION

1. Field of the Invention

The present invention relates to the field of liquid crystal displaying techniques, and in particular to a liquid crystal display panel and manufacturing method thereof.

2. The Related Arts

As the technology develops, video products, in particular, digital video or audiovisual products have been a part of daily lives. Among these digital video or audiovisual products, the display device is an important element for displaying information. Viewers can read information from the display device as well as operate the device.

Liquid crystal display (LCD) panel is a major component of a liquid crystal display device, mainly comprising a color filter (CF) substrate and a thin film transistor (TFT) substrate. The two substrates are disposed with transparent electrodes on inner surfaces facing each other, and a layer of liquid crystal molecules is disposed between the two substrates. The liquid crystal display panel realizes the display capability through the electric field controlling the orientation of liquid crystal molecules to change the optical polarization and with the polarizer for optical passing or blockage.

CF substrate and TFT substrate usually use a radiation curing agent (seal) for assembly. The radiation curing agent usually comprises acrylic, epoxy, photoinitiator, and so on. The radiation curing agent is cured through heating or UV radiation, or both, so CF substrate and TFT substrate are glued together. The current mainstream curing technique is to use both heating and UV radiation. When UV radiation is used to cure the radiation curing agent, the UV light is radiated from one side of TFT substrate. During the curing process, a UV mask is placed between UV light and the TFT substrate to shield UV light from radiating upon the display area and to prevent the UV light from damaging the PI material and liquid crystal material in the display area.

The above method has the following shortcomings: when the panel size changes, a corresponding UV mask must be manufactured, which increases the manufacture cost. Also, because the peripheral of TFT substrate usually includes large-area opaque metal routes, which may shield the radiation curing agent under the metal routes from UV light curing and cause the radiation curing agent to suffer insufficient curing.

### SUMMARY OF THE INVENTION

The technical issue to be addressed by the present invention is to provide a liquid crystal display panel and manufacturing method thereof to solve the problems of high manufacturing cost and insufficient curing of known techniques.

The present invention provides a manufacturing method of liquid crystal display panel, which comprises the steps of: preparing a first substrate and a second substrate, the first substrate and second substrate being disposed oppositely, the first substrate further comprising a color filter array area and a first non-display area disposed in peripheral of the color filter array area, the first substrate or the second substrate being coated with radiation curing agent corresponding to the first non-display area; using curing radiation to shine on the first substrate from a side of the first substrate away from the second substrate so that the incident curing radiation to the color filter array area being absorbed by the color filter array area, and the incident curing radiation to the first non-display area curing the radiation curing agent to adhere the first substrate and the second substrate.

According to a preferred embodiment of the present invention, the second substrate comprises a thin film transistor array area corresponding to the color filter array area, and a second non-display area disposed in peripheral of the thin film transistor array area, the second non-display area includes a first black matrix, and the radiation curing agent is coated on the first black matrix or the area on the first non-display area corresponding to the first black matrix.

According to a preferred embodiment of the present invention, the color filter array area comprises a plurality of color filter units arranged in an array format, and thin film transistor array area comprises a second black matrix corresponding to border area between color filter units.

According to a preferred embodiment of the present invention, the first black matrix and the second black matrix are formed at the same time.

According to a preferred embodiment of the present invention, the color filter array area comprises a plurality of color filter units arranged in an array format, and a second black matrix disposed between color filter units.

According to a preferred embodiment of the present invention, the radiation curing agent is an UV curing agent and the curing radiation is UV light.

The present invention provides a liquid crystal display panel, which comprises: a first substrate, further comprising color filter array area and a first non-display area disposed in peripheral of the color filter array area; a second substrate, disposed opposite to the first substrate, further comprising a thin film transistor array area corresponding to the color filter array area, and a second non-display area disposed in peripheral of the thin film transistor array area, the second non-display area including a first black matrix; radiation curing agent, coating on the first black matrix to adhere the first substrate and the second substrate.

According to a preferred embodiment of the present invention, the color filter array area comprises a plurality of color filter units arranged in an array format, and thin film transistor array area comprises a second black matrix corresponding to border area between color filter units.

According to a preferred embodiment of the present invention, the first black matrix and the second black matrix are formed at the same time.

According to a preferred embodiment of the present invention, the color filter array area comprises a plurality of color filter units arranged in an array format, and a second black matrix disposed between color filter units.

According to a preferred embodiment of the present invention, the radiation curing agent is an UV curing agent.

The present invention provides a manufacturing method of liquid crystal display panel, which comprises the steps of: preparing a first substrate and a second substrate, the first substrate and second substrate being disposed oppositely, the first substrate further comprising a color filter array area and a first non-display area disposed in peripheral of the color filter array area, the second substrate further comprising a thin film transistor array area corresponding to the color filter array area, and a second non-display area disposed in peripheral of the thin film transistor array area, the second non-display area including a first black matrix, the color filter array area comprising a plurality of color filter units arranged in an array format, the thin film transistor array area comprising second black matrix corresponding to border area between color filter units; the first back matrix or the area of the first non-display area corresponding to the first black matrix being coated with radiation curing agent; using curing radiation to shine on the first substrate from a side of the first substrate away from the second substrate so that the incident curing radiation to the color filter array area being absorbed by the color filter array area, and the incident curing radiation to the first non-display area curing the radiation curing agent to adhere the first substrate and the second substrate.

According to a preferred embodiment of the present invention, the first black matrix and the second black matrix are formed at the same time.

According to a preferred embodiment of the present invention, the radiation curing agent is an UV curing agent and the curing radiation is UV light.

The efficacy of the present invention is that to be distinguished from the state of the art. The manufacturing method of liquid crystal display device according to the present invention uses curing radiation to shine from one side of the substrate having the color filter array area. By using color filter array area to absorb the incident the curing radiation and using the non-display area in the peripheral area of the color filter array area to allow the curing radiation to pass through and cure the radiation curing agent, the method effectively solves the insufficient curing problem caused by the shielding of metal routes of the peripheral of thin film transistor array area and reduces the manufacture cost of the liquid crystal display panel without using UV mask.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the flowchart of manufacturing method of liquid crystal display panel according to the present invention;

FIG. 2 is a schematic view showing an embodiment of structure of the liquid crystal display panel manufactured according to the method in FIG. 1; and

FIG. 3 is a schematic view showing another embodiment of structure of the liquid crystal display panel manufactured according to the method in FIG. 1.

### DETAILED DESCRIPTION OF THE PREFERRED EMBODIMENTS

The following detailed description refers to figures and embodiments of the present invention.

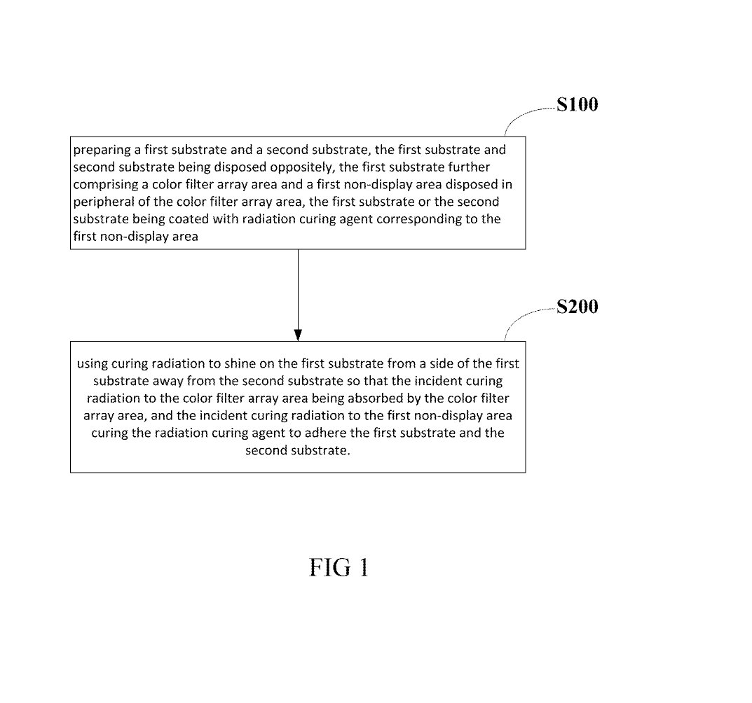

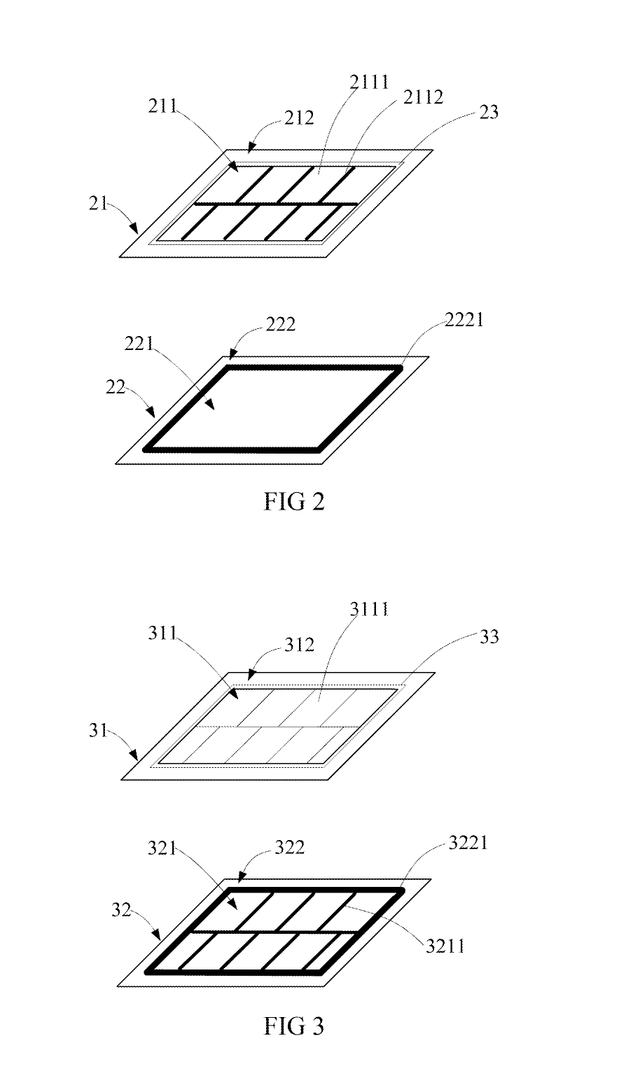

FIG. 1 is a schematic view showing the flowchart of manufacturing method of liquid crystal display device according to the present invention, and FIG. 2 is a schematic view showing an embodiment of structure of the liquid crystal display panel manufactured according to the method in FIG. 1. The manufacturing method of liquid crystal display panel comprises the following steps:

Step S100: preparing a first substrate 21 and a second substrate 22, the first substrate 21 and the second substrate 22 being disposed oppositely.

In the present embodiment, first substrate 21 further comprises a color filter array area 211 and a first non-display area 212 disposed in peripheral of color filter array area 211. Second substrate 22 comprises a thin film transistor. array area 221 corresponding to color filter array area 211, and a second non-display area 222 disposed in peripheral of thin film transistor array area 221. Second non-display area 222 includes a first black matrix 2221. Thin film transistor array area 221 comprises an array area having thin film transistor (TFT, not shown) and pixel electrodes (not shown). First black matrix 2221 surrounds thin film transistor array area 221, for preventing the peripheral area from bad conduction caused by the curing radiation diffraction.

In the present embodiment, color filter array area 211 comprises a plurality of color filter units 2111 arranged in an array format, and second black matrix 2112 between color filter units 2111; wherein a plurality of color filter units 2111 is for allowing pre-defined wavelength light to pass, and reflecting or absorbing other wavelength light to achieve the color display of liquid crystal display panel. A plurality of color filter units 2111 usually is arranged in an interweaving manner according to different base color, for example, red, green, and blue. Second black matrix 2112 is mainly for preventing light leaking between color filter units 2111 to enhance the color contrast of liquid crystal display panel.

In the present embodiment, the area of first non-display area 212 corresponding to first black matrix 2221 is coated with radiation curing agent 23. In another embodiment, radiation curing agent 23 can also be coated onto first black matrix 2221, or any appropriate area on first substrate 21 or second substrate 22 corresponding to first non-display area 212.

Step S200: using curing radiation to shine on first substrate 21 from a side of first substrate 21 away from second substrate 22 so that the incident curing radiation to color filter array area 211 being absorbed by color filter array area 211, and the incident curing radiation to first non-display area 212 curing radiation curing agent 23 to adhere first substrate 21 and second substrate 22.

In the present embodiment, radiation curing agent 23 is preferably an UV curing agent and the curing radiation is preferably UV light. When UV light shines from one side of first substrate 21, color filter units 2111 and second black matrix 2112 of color filter array area 211 on first substrate 21 will absorb about 95% of the UV light, and first non-display area 212 in the peripheral of color filter array area 211 cannot absorb any UV light. After the incident UV light arriving at radiation curing agent 23 on first non-display area 212, the photoinitiator in radiation curing agent 23 absorbs the photonic energy of UV light and is decomposed into free radical causing the monomers to polymerize to adhere first substrate 21 and second substrate 22; wherein during the curing, the preferred manner is to use both heating and curing radiation.

FIG. 3 is a schematic view showing another embodiment of structure of the liquid crystal display panel manufactured according to the method in FIG. 1. As shown in FIG. 3, the liquid crystal display panel of the present invention comprises a first substrate 31 and a second substrate 32, disposed oppositely.

In the present embodiment, first substrate 31 further comprises a color filter array area 311 and a first non-display area 312 disposed in peripheral of color filter array area 311. Second substrate 32 comprises a thin film transistor array area 321 corresponding to color filter array area 311, and a second non-display area 322 disposed in peripheral of thin film transistor array area 321. Second non-display area 322 includes a first black matrix 3221. Thin film transistor array area 321 includes second black matrix 3211. Color filter array area 311 comprises a plurality of color filter units 3111, arranged in an array format. Second black matrix 3211 is located at an area corresponding to border area between color filter units 3111.

In the present embodiment, the area of first non-display area 312 corresponding to first black matrix 3221 is coated with radiation curing agent 33. In another embodiment, radiation curing agent 33 can also be coated onto first black matrix 3221, or any appropriate area on first substrate 31 or second substrate 32 corresponding to first non-display area 312.

The difference between the present embodiment and the embodiment in FIG. 2 is that, first black matrix 3221 and second black matrix 3211 are both formed on second substrate 32, and can be formed at the same time to eliminate the step of forming second black matrix 3211 on first substrate 31, and simplifies the manufacture process. When curing radiation shines on first substrate 31 from one side of first substrate 31 away from second substrate 32, color filter units 3111 of color filter array area 311 on first substrate 31 will absorb most of the curing radiation, and first non-display area 312 in the peripheral of color filter array area 311 cannot absorb any curing radiation, resulting in curing radiation curing agent 33. At this point, even though a small amount of curing radiation will penetrate from between color filter units 3111, the penetrating curing radiation will be shielded by second black matrix 3211 on second substrate 32; hence, having no impact on display effect.

The present invention further provides liquid crystal display panels manufactured according to the aforementioned manufacturing methods. The structures are described in details in the above description and are thus not repeated here.

With the above method, the present invention uses curing radiation to shine from one side of the substrate having the color filter array area. By using color filter array area to absorb the incident the curing radiation and using the non-display area in the peripheral area of the color filter array area to allow the curing radiation to pass through and cure the radiation curing agent, the method effectively solves the insufficient curing problem caused by the shielding of metal routes of the peripheral of thin film transistor array area and reduces the manufacture cost of the liquid crystal display panel without using UV mask.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A manufacturing method of liquid crystal display panel, which comprises the steps of:
preparing a first substrate and a second substrate, the first substrate and second substrate being disposed oppositely, the first substrate further comprising a color filter array area and a first non-display area disposed in peripheral of the color filter array area, the first substrate or the second substrate being coated with radiation curing agent corresponding to the first non-display area; and
using curing radiation to shine on the first substrate from one side of the first substrate away from the second substrate so that the incident curing radiation to the color filter array area being absorbed by the color filter array area, and the incident curing radiation to the first non-display area curing the radiation curing agent to adhere the first substrate and the second substrate.

2. The manufacturing method as claimed in claim 1, characterized in that the second substrate further comprises a thin film transistor array area corresponding to the color filter array area, and a second non-display area disposed in peripheral of the thin film transistor array area, the second non-display area includes a first black matrix, and the radiation curing agent is coated on the first black matrix or the area on the first non-display area corresponding to the first black matrix.

3. The manufacturing method as claimed in claim 2, characterized in that the color filter array area further comprises a plurality of color filter units arranged in an array format, and thin film transistor array area comprises a second black matrix corresponding to border area between color filter units.

4. The manufacturing method as claimed in claim 3, characterized in that the first black matrix and the second black matrix are formed at the same time.

5. The manufacturing method as claimed in claim 2, characterized in that the color filter array area comprises a plurality of color filter units arranged in an array format, and a second black matrix disposed between color filter units.

6. The manufacturing method as claimed in claim 1, characterized in that the radiation curing agent is an UV curing agent and the curing radiation is UV light.

7. A liquid crystal display panel, comprising:
a first substrate, further comprising color filter array area and a first non-display area disposed in peripheral of the color filter array area;
a second substrate, disposed opposite to the first substrate, further comprising a thin film transistor array area corresponding to the color filter array area, and a second non-display area disposed in peripheral of the thin film transistor array area, the second non-display area including a first black matrix; and
radiation curing agent, coating on the first black matrix to adhere the first substrate and the second substrate.

8. The liquid crystal display panel as claimed in claim 7, characterized in that the color filter array area further comprises a plurality of color filter units arranged in an array format, and thin film transistor array area comprises second black matrix corresponding to border area between color filter units.

9. The liquid crystal display panel as claimed in claim 7, characterized in that the first black matrix and the second black matrix are formed at the same time.

10. The liquid crystal display panel as claimed in claim 9, characterized in that the color filter array area comprises a plurality of color filter units arranged in an array format, and a second black matrix disposed between color filter units.

11. The liquid crystal display panel as claimed in claim 7, characterized in that the radiation curing agent is an UV curing agent.

12. A manufacturing method of liquid crystal display panel, which comprises the steps of:
preparing a first substrate and a second substrate, the first substrate and second substrate being disposed oppositely, the first substrate further comprising a color filter array area and a first non-display area disposed in peripheral of the color filter array area, the second substrate further comprising a thin film transistor array area corresponding to the color filter array area, and a second non-display area disposed in peripheral of the thin film transistor array area, the second non-display area comprising a first black matrix, the color filter array area comprising a plurality of color filter units arranged in an array format, the thin film transistor array area comprising second black matrix corresponding to border area between color filter units; the first back matrix or the area of the first non-display area corresponding to the first black matrix being coated with radiation curing agent; and
using curing radiation to shine on the first substrate from a side of the first substrate away from the second substrate so that the incident curing radiation to the color filter array area being absorbed by the color filter array area, and the incident curing radiation to the first non-display area curing the radiation curing agent to adhere the first substrate and the second substrate.

13. The manufacturing method as claimed in claim 12, characterized in that the first black matrix and the second black matrix are formed at the same time.

14. The manufacturing method as claimed in claim 12, characterized in that the radiation curing agent is an UV curing agent and the curing radiation is UV light.
